(19) United States
(12) Patent Application Publication
(10) Pub. No.: US 2026/0062326 A1
(43) Pub. Date: Mar. 5, 2026

(54) SYNTHESIS METHOD FOR LAYERED BIMETAL-BASED NANO LANTHANUM MATERIAL CAPABLE OF SYNCHRONOUSLY LOCKING PHOSPHORUS, REMOVING ALGAE, AND REDUCING TURBIDITY, AND USE THEREOF

(71) Applicant: Nanjing University, Nanjing (CN)

(72) Inventors: Yanyang ZHANG, Nanjing (CN); Chaoyang SHEN, Nanjing (CN); Bo KONG, Nanjing (CN); Yulu JIA, Nanjing (CN); Bingcai PAN, Nanjing (CN); Weiming ZHANG, Nanjing (CN)

(21) Appl. No.: 19/383,427

(22) Filed: Nov. 7, 2025

Related U.S. Application Data
(63) Continuation of application No. PCT/CN2023/095666, filed on May 23, 2023.

(51) Int. Cl. C02F 1/52; B01J 20/02; B01J 20/28; B01J 20/30; C02F 1/28; C02F 101/10; C02F 101/30

(52) U.S. Cl. CPC C02F 1/5245; B01J 20/0207; B01J 20/28004; B01J 20/3021; B01J 20/3071; B01J 20/3078; C02F 1/281; C02F 2101/105; C02F 2101/30

(57) ABSTRACT

The present invention discloses a synthesis method for a layered dimetal-based nano lanthanum material capable of synchronously locking phosphorus, removing algae, and reducing turbidity, and the use thereof, and belongs to the field of environmental functional materials. In the present invention, a synthesis method includes: synthesizing LDHs by means of a single-drop coprecipitation method; filtering out an obtained product, washing the product with distilled water and drying; then adding the product to an alcohol solution of a lanthanum salt at certain concentration, and stirring for reaction; precipitating lanthanum ions in situ by adjusting a pH value of the solution; filtering out the reaction precipitate, washing the precipitate with an alcohol, and drying the precipitate to obtain an LDH-based nano lanthanum material.

### CROSS-REFERENCE TO RELATED APPLICATION

This application is a by-pass continuation application of International Patent Application No. PCT/CN2023/095666, filed on May 23, 2023, the contents of which are incorporated by reference.

### TECHNICAL FIELD

The present invention belongs to the technical fields of environmental functional materials and water treatment, and more specifically relates to a synthesis method for an LDH-based nano lanthanum material capable of synchronously locking phosphorus, removing algae, and reducing turbidity, and the use thereof.

### BACKGROUND

The eutrophication of water is currently a serious global environmental problem, and excessive phosphorus in water bodies is a key factor for this issue. Phosphorus control in water bodies has become an important means to curb eutrophication. In addition to traditional coagulants and precipitants such as iron salts, aluminum salts, and calcium salts, there have been more studies on high-efficiency phosphorus adsorbents for natural water bodies such as lakes in recent years. Lanthanum is a rare earth element with low toxicity and abundant reserves, and has received continuous attention in the field of phosphorus removal due to its strong affinity with phosphates. A phosphorus locking agent Phoslock used in “Application of Phoslock™, an innovative phosphorus binding clay, to two Western Australian waterways: preliminary findings”, Hydrobiologia, vol. 494, 2003, has been successfully commercialized and used for phosphorus removal in over 200 lakes around the world with a good effect since its development by the Commonwealth Scientific and Industrial Research Organization (CSIRO) of Australia in the 1990s.

Phoslock is a lanthanum-modified bentonite, and Douglas (U.S. Pat. No. 6,350,383B1. 2002 Feb. 26) introduced its main synthesis method: mix a 0.1 M LaCl₃ solution with high-purity bentonite at a liquid-solid ratio of 100:1 and stir for 24 h for ion exchange reaction; perform centrifugal separation, and repeat the ion exchange step once to ensure that La³⁺ fully replaces interlayer cations of the bentonite; wash three times with distilled water to remove residual La³⁺, perform centrifugal separation, and dry to obtain the final product. The product has a lanthanum loading capacity of about 5% and a phosphorus removal capacity of about 10 mg P/g. Due to its full exertion of lanthanum in phosphorus removal, the product has a good phosphorus locking effect, and the product is easy to industrialize due to simple synthesis principle and operating steps and thus is widely applied. However, there are still some shortcomings of the phosphorus locking agent in practical applications, such as low lanthanum loading capacity, weak flocculation ability, and inability to exert the phosphorus removal ability when there is a large amount of suspended solids in the water bodies.

At present, the treatment of eutrophic lakes mostly uses a Flock and Lock method. First, coagulants such as polyaluminum chloride or polyferric chloride are added to remove suspended algae and other particles on the lake surface, and then, phospholock is added multiple times to achieve a continuous phosphorus locking effect. As in “Management of eutrophication in Lake De Kuil (The Netherlands) using combined flocculant e Lanthanum modified bentonite treatment”, published on Water Research, volume 97, 2016, the treatment of eutrophication in Lake De Kuil (The Netherlands) involves adding ferric chloride on the first day to settle algae and other suspended solids in water, followed by multiple additions of Phoslock on the second and third days to achieve a phosphorus removal effect. As in “Controlling eutrophication by combined bloom precipitation and sediment phosphorus inactivation”, published on Water Research, vol. 47, 2013, the treatment of eutrophication in Lake Rauwbraken involves adding a mixed agent of PAC and Phoslock to precipitate cyanobacteria and reduce total phosphorus in the lake. Although Flock and Lock can treat eutrophic lakes, they fundamentally fail to overcome the shortcomings of Phoslock, and the combination of coagulants and a phosphorus locking agent not only increases costs, but also brings more ecological risks.

Layered dimetallic hydroxides (LDHs) are clay minerals having a strong anion exchange ability, commonly found in the form of hydrotalcite in nature, and can also be synthesized artificially. The LDHs have great adsorption potential due to dual properties of metal hydroxides and anion exchangers thereof and are suitable for use as carrier materials for phosphorus removal agents. The LDHs have many excellent characteristics due to diverse types of central metal ions and interlayer anions as well as a flexible and adjustable layered structure, and have received considerable attention in various fields. There have been many studies on the use of LDHs for phosphorus removal and coagulation. For example, in “Adsorption of phosphate by layered double hydroxides in aqueous solutions” published on Applied Clay Science, vol. 32, 2006, it is researched that various LDHs have high efficiency on removal of orthophosphate (PO4); and in “Size- and surface charge-controlled layered double hydroxides for efficient algal flocculation” published on Environment Science Nano, vol. 5, 2018, it is researched that Mg/Al-LDHs of different sizes can remove Microcystis aeruginosa from water through electrostatic adsorption and sweep flocculation of precipitate.

The lanthanum element has attracted attention due to its specific binding with phosphates, but also has potential properties in coagulation. For example, in “Application of cerium and lanthanum coagulants in wastewater treatment—A comparative assessment to magnesium, aluminum, and iron coagulants” published in Chemical Engineering Journal, vol. 426, 2021, it is researched that LaCl₃ can be used for treating high phosphorus wastewater via coagulation, forming dense precipitate and accelerating flocculation. In “Analysis of mechanism of rare earth lanthanum-modified polyferric sulfate, and application thereof”, published on Environmental Chemistry, vol. 39, 2020, it is researched that in lanthanum-modified polyferric sulfate, because lanthanum is easy to be hydrolyzed and competes with iron to bind with hydroxyl groups to form cross copolymerization and interconnection, a chain structure of the flocculant is lengthened, the sweep flocculation effect of the flocculant on precipitate is strengthened, and flocculation is accelerated. Based on the above theory, we hope to use LDHs as a carrier and modify the LDHs with lanthanum to develop a new type of phosphorus locking agent for lakes. By regulating the distribution and morphology of La, the phosphorus locking and coagulation capabilities of lanthanum can be exerted.

### SUMMARY

To address the problems of complex operations, increased potential ecological risks, and higher human and material resource consumption in the current methods for treating eutrophic lakes, the present invention provides an LDH-based nano lanthanum material capable of synchronously locking phosphorus, removing algae, and reducing turbidity.

The technical solution of the present invention is as follows: a layered dimetal-based nano lanthanum material capable of synchronously flocculating and locking phosphorus includes the following steps:
1) preparing a mixed solution of double metal salts as a solution A, and preparing a precipitant solution as a solution B;
2) taking certain amount of solution B, slowly pumping the solution A into the solution B to perform a coprecipitation reaction, continuously stirring the reaction system to mix evenly, and ending the reaction when observing that the pH reaches a specific value;
3) allowing a reaction product obtained in step 2) to stand in a water bath at certain temperature;
4) performing centrifugal separation on a product of step 3), washing the product with distilled water until the product is neutral, and freeze drying and grinding the product into powder to obtain the product LDHs;
5) adding the LDHs to an alcohol solution of a lanthanum salt at certain concentration and stirring for reaction;
6) adjusting the pH of the reaction system in step 5) to a specific value and continuing stirring for reaction; and
7) filtering out a product obtained in step 6), washing the product with alcohol until the product is neutral, and freeze drying the product to obtain the layered dimetal-based nano lanthanum material.

The mixed solution of the double metal salts in step 1) includes a divalent metal salt and a trivalent metal salt. The divalent metal salt is a magnesium salt, and the magnesium salt is MgCl₂ or Mg(NO₃)₂. The trivalent metal salt is an iron salt, and the iron salt is FeCl₃ or Fe(NO)₃)₃. A molar ratio of the divalent salt to the trivalent salt in the double metal salts is 2:1 to 4:1. The total concentration of the double metal salts in the solution A is 1-4 mol·L⁻¹. The solution B in step 1) is a NaOH solution with a concentration of 1-3 mol·L⁻¹; or the solution B is a mixed solution of NaOH and Na₂CO₃, where a molar concentration ratio of the NaOH to the Na₂CO₃ is 12:1 to 8:1. The layered dimetal-based nano lanthanum material is used for flocculating suspended solids in a water body, and also adsorbing phosphorus from the water body.

Further, the pH at the end of the reaction in step 2) is 9.0-11.0, and in step 3), the water bath temperature is 50° C.-80° C., and the water bath time is 12-24 h.

Further, the lanthanum salt in step 5) is LaCl₃ or La(NO₃)₃; the concentration of lanthanum ions in the alcohol solution of the lanthanum salt is 1-40 g·L⁻¹; and the stirring for reaction in step 5) is performed at a solid-liquid ratio of 1:5 to 1:200 for a stirring time of 12-24 h, and the alcohol is methanol or ethanol.

Further, HCl/NaOH is used in step 6) to adjust the pH of the system, the concentration of the regulator is 0.1-5 mol·L⁻¹, and the pH of the system is adjusted to 10.0-12.0.

Further, the layered dimetal-based nano lanthanum material is an Mg/Fe-LDH-based nano lanthanum material, abbreviated as La-MF. The La-MF material is white powder. The La-MF material has a particle size of 1-10 μm, and a lanthanum loading capacity in the La-MF material is 5-30%.

Further, the layered dimetal-based nano lanthanum material prepared is used for flocculating suspended solids in the water body, and also adsorbing phosphorus from the water body.

Compared to the prior art, the beneficial effects of the present invention are as follows:
(1) The material utilizes the hydroxyl groups on the surface of the LDH to adsorb La³⁺, and complex anions such as [LaCl₄]⁻ and [LaCl₅]²⁻ can be generated in an alcohol phase to intercalate between the layers of the LDH, thus exhibiting a high adsorption capacity for La³⁺. The lanthanum loading capacity can be controlled by adjusting the concentration of lanthanum in a mother liquor, and the lanthanum loading capacity in the material can be adjusted in a range of 5-30%.
(2) The material is precipitated in situ by adjusting the pH after lanthanum loading, so that most of La³⁺ loaded between the layers or attached to the surface of the LDH exists in a weak crystalline state of La(OH)₃. When the material is added to a water body, some of lanthanum may be hydrolyzed to generate a large number of positive charges, and is complexed with hydroxyl groups on the surface of the LDH to form a chain structure of [La(OH)ₘ(H₂O)ₙ]^{(3-m)+}, to exert the functions of adsorption and charge neutralization, sweep flocculation of precipitate, and the like, to rapidly reduce the turbidity and settle algae suspended solids in the water body. Moreover, the specific binding between the La³⁺ and the PO₄³⁻ enables the material to exhibit an excellent long-term phosphorus locking ability.
(3) At present, the treatment of eutrophic lakes via phosphorus locking on the market mainly involves adding coagulants such as polyaluminum chloride and polyferric chloride to coagulate and settle suspended solids in a lake, and then, adding commercial phosphorus passivator Phoslock to trap and chelate inorganic phosphorus in the water body during a particle settling process, so as to achieve the effect of phosphorus locking. In contrast, the material of the present invention can achieve a stable phosphorus removal effect while flocculating the suspended solids, can achieve multiple effects with a single addition, and is more convenient and efficient.
(4) This patent uses a single-drop method to synthesize the carrier LDH, with a single synthesis amount that can reach tens or even hundreds of times that of a double-drop method in patent (CN112237897B). Moreover, this patent does not use high-temperature calcination in the synthesis, has fewer and simpler synthesis steps, and is conducive to industrial production.

### BRIEF DESCRIPTION OF THE DRAWINGS

FIG. 1 shows a process flowchart of a preparation method of the present invention.

FIG. 2a shows an SEM image of La-MF-1 prepared in Embodiment 1 of the present invention.

FIG. 2b shows a TEM image of La-MF-1 prepared in Embodiment 1 of the present invention.

FIG. 3 shows an XRD pattern of La-MF-1 and an Mg/Fe-LDH carrier prepared in Embodiment 1 of the present invention.

FIG. 4 shows an XRD pattern of La-MF-2 and an Mg/Fe-LDH carrier prepared in Embodiment 2 of the present invention.

FIG. 5 shows an XRD pattern of La-MF-3 and an Mg/Fe-LDH carrier prepared in Embodiment 2 of the present invention.

FIG. 6 shows removal ratios of La-MF-1 prepared in Embodiment 1 of the present invention for suspended solids and phosphates in a water body at different doses.

FIG. 7 shows schematic structural diagrams of La-MF prepared in Embodiment 1 of the present invention.

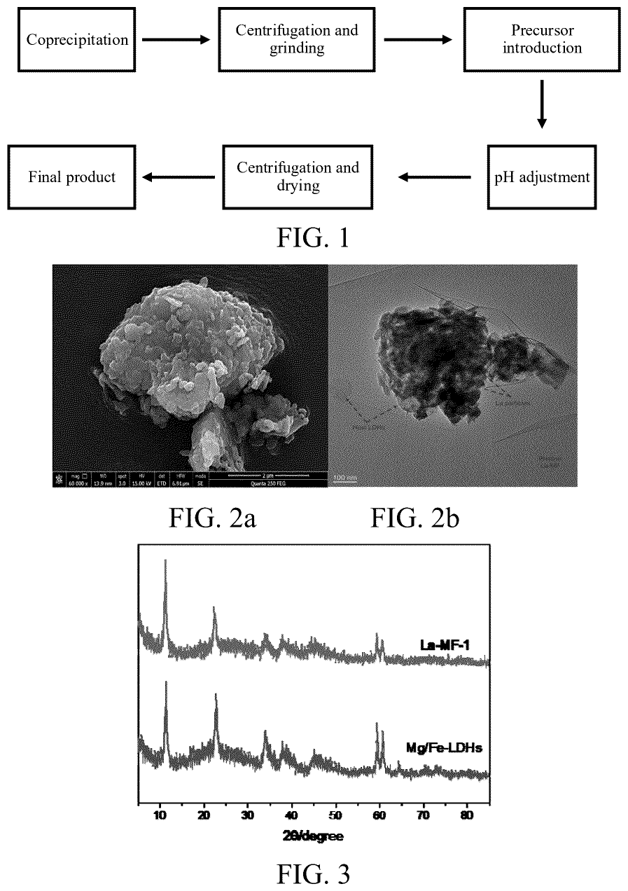

### DETAILED DESCRIPTION

The present invention is further described below with reference to specific embodiments.

### Embodiment 1

1) A mixed solution of double metal salts MgCl₂ (0.9 mol·L⁻¹) and FeCl₃ (0.3 mol·L⁻¹) was prepared as a solution A, and a precipitant solution of NaOH (2 mol·L⁻¹) and Na₂CO₃ (0.2 mol·L⁻¹) was prepared as a solution B.
2) Certain amount of solution B was taken, the solution A was slowly pumped into the solution B to perform a coprecipitation reaction, the reaction system was continuously stirred to mix evenly, and the reaction was ended when observing that the pH reached 9.0.
3) A reaction product obtained in step 2) was allowed to stand in a water bath at 65° C. for 18 h to perform water bath heating crystallization.
4) Centrifugal separation was performed on a product of step 3), the product was washed with distilled water until the product was neutral, freeze dried, and ground into powder to obtain a product Mg/Fe-LDH.
5) The Mg/Fe-LDH powder material was added to an ethanol solution (0.375 g La·L⁻¹) (1 g·L⁻¹ LaCl₃·7H₂O) and stirred for 12 h at a solid-liquid ratio of 1:50 for reaction.
6) The pH of the reaction system in step 5) was adjusted to 12.0 and stirring was continued for 12 h.
7) A precipitate reaction product obtained in step 6) was filtered out, washed with ethanol until the product was neutral, and freeze dried to obtain the layered dimetal-based nano lanthanum material (named La-MF-1).

The material prepared in the present embodiment is white powder, and the carrier Mg/Fe-LDH exhibits a sheet-like structure with a particle size of 1-10 μm. The particle size of lanthanum nanoparticles is about 5-10 nm. After digestion, the lanthanum loading capacity is 13.12% as measured by ICP, it indicates successful loading of lanthanum. Lanthanum is distributed in the carrier in the form of nanoparticles, as shown in FIG. 2a and FIG. 2b. An XRD test was conducted on samples, and the results are shown in FIG. 3. The material retains the characteristic peaks of the carrier LDH, it indicates that the layered structure of the carrier material still exists. There are no obvious characteristic peaks related to lanthanum in the XRD pattern, it indicates that lanthanum is most likely to exist in the material in an amorphous or weakly crystalline state. A BET structure shows that the material has a specific surface area of 179.5 m²·g⁻¹, with pores mostly being mesopores at 2-25 nm. The large specific surface area and rich pore structure are conducive to the adsorption of PO₄³⁻ by the material.

### Embodiment 2

1) A mixed solution of double metal salts MgCl₂ (0.9 mol·L⁻1) and FeCl₃ (0.3 mol·L⁻¹) was prepared as a solution A, and a precipitant solution of NaOH (2 mol·L⁻¹) and Na₂CO₃ (0.2 mol·L⁻¹) was prepared as a solution B.
2) Certain amount of solution B was taken, the solution A was slowly pumped into the solution B to perform a coprecipitation reaction, the reaction system was continuously stirred to mix evenly, and the reaction was ended when observing that the pH reached 9.0.
3) A reaction product obtained in step 2) was allowed to stand in a water bath at 65° C. for 18 h to perform water bath heating crystallization.
4) Centrifugal separation was performed on a product of step 3), the product was washed with distilled water until the product was neutral, freeze dried, and ground into powder to obtain a product Mg/Fe-LDH.
5) The Mg/Fe-LDH powder material was added to an ethanol solution (0.375 g La·L⁻¹) (1 g·L⁻¹ LaCl₃·7H₂O) and stirred for 12 h at a solid-liquid ratio of 1:50 for reaction.
6) A precipitate reaction product obtained in step 5) was filtered out, washed with ethanol until the product was neutral, and freeze dried to obtain the layered dimetal-based nano lanthanum material (named La-MF-2).

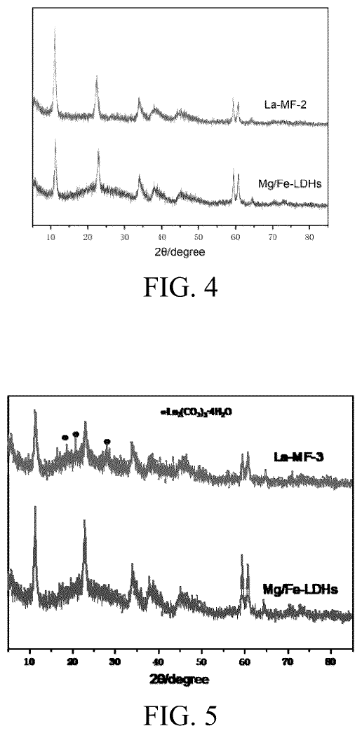

The material prepared in the present embodiment is white powder, and the carrier Mg/Fe-LDH exhibits a sheet-like structure with a particle size of 1-10 μm. The particle size of lanthanum nanoparticles is about 5-10 nm. After digestion, the lanthanum loading capacity is 8.73% as measured by ICP, it indicates successful loading of lanthanum. An XRD test was conducted on samples, and the results are shown in FIG. 4. Because the material was not subjected to in-situ precipitation after lanthanum loading in the present embodiment, lanthanum mainly existed in a free state between the layers and on the surface, and the free state La could not be observed by XRD.

### Embodiment 3

1) A mixed solution of double metal salts MgCl₂ (0.9 mol·L⁻1) and FeCl₃ (0.3 mol·L⁻¹) was prepared as a solution A, and a precipitant solution of NaOH (2 mol·L⁻¹) and Na₂CO₃ (0.2 mol·L⁻¹) was prepared as a solution B.
2) Certain amount of solution B was taken, the solution A was slowly pumped into the solution B to perform a coprecipitation reaction, the reaction system was continuously stirred to mix evenly, and the reaction was ended when observing that the pH reached 9.0.
3) A reaction product obtained in step 2) was allowed to stand in a water bath at 65° C. for 18 h to perform water bath heating crystallization.
4) Centrifugal separation was performed on a product of step 3), the product was washed with distilled water until the product was neutral, freeze dried, and ground into powder to obtain a product Mg/Fe-LDH.
5) The Mg/Fe-LDH powder material was added to an ethanol solution (0.375 g La·L⁻¹) (1 g·L⁻¹ LaCl₃·7H₂O) and stirred for 12 h at a solid-liquid ratio of 1:50 for reaction.
6) A precipitate reaction product obtained in step 5) was filtered out, washed with ethanol until the product was neutral, and freeze dried.
7) A material obtained in step 6) was stirred in a 0.2 M NH₄HCO₃ solution for 12 h.
8) A reaction product obtained in step 7) was filtered out, washed with distilled water until the product was neutral, and freeze dried to obtain the layered dimetal-based nano lanthanum material (named La-MF-3).

The material prepared in the present embodiment is white powder, and the carrier Mg/Fe-LDH exhibits a sheet-like structure with a particle size of 1-10 μm. The particle size of lanthanum nanoparticles is about 5-10 nm. After digestion, the lanthanum loading capacity is 8.23% as measured by ICP, it indicates successful loading of lanthanum. An XRD test was conducted on samples, and the results are shown in FIG. 5. Because the material was subjected to in-situ precipitation with the precipitant after lanthanum loading, a large amount of lanthanum was hydrolyzed and bound with carbonate radicals to form lanthanum carbonate crystals.

### Application Example 1

This application example used the La-MF-1 as a material to test flocculation of suspended solids and synchronous phosphorus removal: a mixed solution containing 2 mg P·L⁻¹, kaolin (30 mg·L⁻¹), HA (Humic Acid) (10 mg·L⁻¹), and M. aeruginosa (having an absorbance of 0.2 at 680 nm) was prepared as a target water body to be treated, and doses of the material were 0.05 g·L⁻¹, 0.1 g·L⁻¹, 0.2 g·L⁻¹, 0.3 g·L⁻¹, 0.4 g·L⁻¹, and 0.5 g·L⁻¹, respectively. Coagulation experiment operations were simulated at an initial pH of 8.0. A mixture was stirred at 600 rpm for 2 min and then at 120 rpm for 15 min, and allowed to stand for 1 h. The supernatant was taken to measure turbidity, chlorophyll-a concentration, absorbance at 254 nm, and PO₄³⁻ concentration.

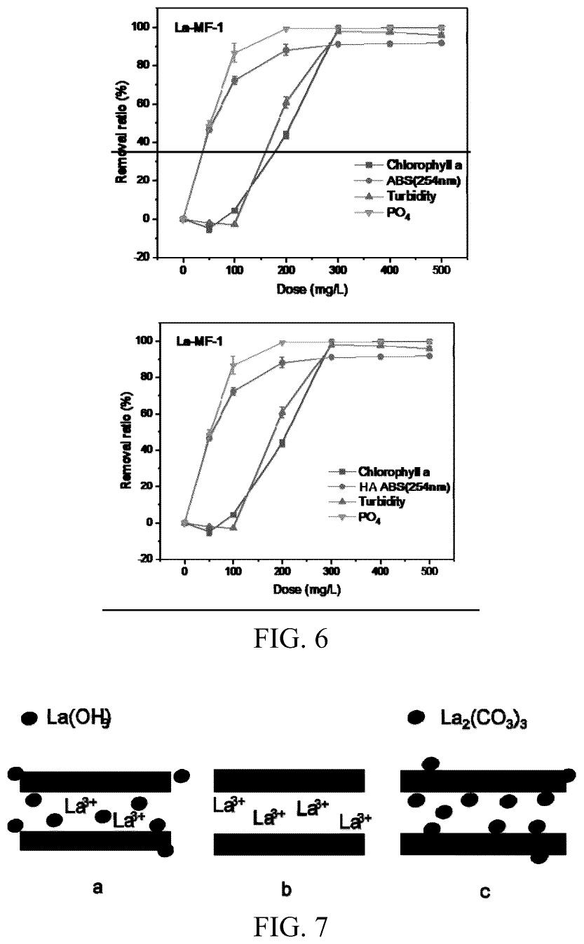

As shown in FIG. 6, when the dose of the La-MF-1 is 0.3 g·L⁻¹, the turbidity removal ratio is 97.98%, the chlorophyll a removal ratio is 97.86%, the HA (ABS, 254 nm) removal ratio is 91.44%, and the PO₄³⁻ removal ratio is 99.87%. The results indicate that the material has good flocculation and phosphorus removal effects at the dose of 0.3 g·L⁻¹. As shown in FIG. 7a, lanthanum exists in the material in a weak crystalline state and a small amount in a free state. When the material is added to the water body, some of lanthanum may be hydrolyzed to generate a large number of positive charges, and is complexed with hydroxyl groups on the surface of the LDH to form a chain structure of [La(OH)ₘ(H₂O)ₙ]^{(3-m)+}, to exert the functions of adsorption and charge neutralization, sweep flocculation of precipitate, and the like, to rapidly reduce the turbidity and settle algae suspended solids in the water body. Moreover, the specific binding between the La³⁺ and the PO₄³⁻ enables the material to exhibit an excellent long-term phosphorus locking ability.

Under the same initial conditions, the La-MF-2 material maintains good removal ratios for turbidity, chlorophyll a and HA, but has a poor phosphorus removal effect, with only a 40% phosphorus removal ratio at a dose of 0.5 g/L. As shown in FIG. 7b, lanthanum exists in the material in a free state, and thus is hydrolyzed to generate a large amount of positive charges, to remove suspended solids via adsorption and charge neutralization and sweep flocculation of precipitate, but also binds and competes with phosphorus for adsorption sites, resulting in a significant decrease in phosphorus removal effect.

### Application Example 2

This application example used the La-MF-3 as a material to test the basic performance of phosphorus removal and flocculation: a solution containing 50 mg P·L⁻¹ was prepared to test the phosphorus adsorption capacity; and a solution containing kaolin (30 mg·L⁻¹), HA (10 mg·L⁻¹), and M. aeruginosa (having an absorbance of 0.2 at 680 nm) was prepared to test the flocculation performance, and the dose of the material was 0.5 g·L⁻¹. At an initial pH of 8.0, the adsorption capacity was measured by reacting at 180 rpm for 72 h. Coagulation experiment operations were simulated. The mixture was stirred at 600 rpm for 2 min and then at 120 rpm for 15 min, and allowed to stand for 1 h. The supernatant was taken to measure turbidity, chlorophyll-a concentration, and absorbance at 254 nm.

The La-MF-3 has an adsorption capacity of 37.88 mgP/g, which is excellent in performance, but performs poorly in flocculation performance, with almost a removal ratio of 0 for chlorophyll a, a removal ratio of 9.02% for turbidity, and a removal ratio of 27.42% for HA. As shown in FIG. 7c, lanthanum exists between the layers and on the surface of the material as stable lanthanum carbonate, and thus the material performs well in phosphorus removal. However, due to the inability to hydrolyze and generate positive charges and a chain-like structure, the material performs poorly in flocculation.

The embodiments described above are only some embodiments of the present invention, and the implementations of the present invention are not limited by the embodiments. Various forms of combinations of the solutions in the embodiments, as well as any other changes, modifications, substitutions, or combinations that do not deviate from the spirit and principles of the present invention, should be equivalent replacements and are within the scope of protection of the present invention.

What is claimed is:

1. A method for preparing a layered dimetal-based nano lanthanum material capable of synchronously flocculating and locking phosphorus, comprising the following steps:
1) preparing a mixed solution of double metal salts as a solution A, and preparing a precipitant solution as a solution B;
2) taking certain amount of solution B, slowly pumping the solution A into the solution B to perform a coprecipitation reaction, continuously stirring the reaction system to mix evenly, and ending the reaction when observing that the pH reaches a specific value;
3) allowing a reaction product obtained in step 2) to stand in a water bath at certain temperature;
4) performing centrifugal separation on a product of step 3), washing the product with distilled water until the product is neutral, and freeze drying and grinding the product into powder to obtain the product LDHs;
5) adding the LDHs to an alcohol solution of a lanthanum salt at certain concentration and stirring for reaction;
6) adjusting the pH of the reaction system in step 5) to a specific value and continuing stirring for reaction; and
7) filtering out a product obtained in step 6), washing the product with alcohol until the product is neutral, and freeze drying the product to obtain the layered dimetal-based nano lanthanum material;
wherein the mixed solution of the double metal salts in step 1) comprises a divalent metal salt and a trivalent metal salt, wherein the divalent metal salt is a magnesium salt, the magnesium salt is MgCl₂ or Mg (NO₃)₂; the trivalent metal salt is an iron salt, the iron salt is FeCl₃ or Fe(NO₃)₃; a molar ratio of the divalent salt to the trivalent salt in the double metal salts is 2:1 to 4:1; the total concentration of the double metal salts in the solution A is 1-4 mol·L⁻¹; the solution B in step 1) is a NaOH solution with a concentration of 1-3 mol·L⁻¹; or the solution B is a mixed solution of NaOH and Na₂CO₃, wherein a molar concentration ratio of the NaOH to the Na₂CO₃ is 12:1 to 8:1; and the layered dimetal-based nano lanthanum material is used for flocculating suspended solids in a water body, and also adsorbing phosphorus from the water body.

2. The preparation method according to claim 1, wherein the pH at the end of the reaction in step 2) is 9.0-11.0, and in step 3), the water bath temperature is 50° C.-80° C., and the water bath time is 12-24 h.

3. The preparation method according to claim 1, wherein the lanthanum salt in step 5) is LaCl₃ or La(NO₃)₃; the concentration of lanthanum ions in the alcohol solution of the lanthanum salt is 1-40 g·L⁻¹; and the stirring for reaction in step 5) is performed at a solid-liquid ratio of 1:5 to 1:200 for a stirring time of 12-24 h, and the alcohol is methanol or ethanol.

4. The preparation method according to claim 1, wherein HCl/NaOH is used in step 6) to adjust the pH of the system, the concentration of the regulator is 0.1-5 mol·L⁻¹, and the pH of the system is adjusted to 10.0-12.0.

5. A layered dimetal-based nano lanthanum material prepared by the preparation method according to claim 1, wherein the layered dimetal-based nano lanthanum material is an Mg/Fe-LDH-based nano lanthanum material, abbreviated as La-MF, the La-MF material is white powder, the La-MF material has a particle size of 1-10 μm, and a lanthanum loading capacity in the La-MF material is 5-30%.

6. Use of the layered dimetal-based nano lanthanum material according to claim 5, wherein the layered dimetal-based nano lanthanum material prepared is used for flocculating suspended solids in a water body, and also adsorbing phosphorus from the water body.

7. A layered dimetal-based nano lanthanum material prepared by the preparation method according to claim 2, wherein the layered dimetal-based nano lanthanum material is an Mg/Fe-LDH-based nano lanthanum material, abbreviated as La-MF, the La-MF material is white powder, the La-MF material has a particle size of 1-10 μm, and a lanthanum loading capacity in the La-MF material is 5-30%.

8. A layered dimetal-based nano lanthanum material prepared by the preparation method according to claim 3, wherein the layered dimetal-based nano lanthanum material is an Mg/Fe-LDH-based nano lanthanum material, abbreviated as La-MF, the La-MF material is white powder, the La-MF material has a particle size of 1-10 μm, and a lanthanum loading capacity in the La-MF material is 5-30%.

9. A layered dimetal-based nano lanthanum material prepared by the preparation method according to claim 4, wherein the layered dimetal-based nano lanthanum material is an Mg/Fe-LDH-based nano lanthanum material, abbreviated as La-MF, the La-MF material is white powder, the La-MF material has a particle size of 1-10 μm, and a lanthanum loading capacity in the La-MF material is 5-30%.
